(19) United States
(12) Patent Application Publication
(10) Pub. No.: US 2024/0057553 A1
(43) Pub. Date: Feb. 22, 2024

(54) Animal Tag

(71) Applicant: S.C.R. (ENGINEERS) LIMITED, Netanya (IL)

(72) Inventors: Mordehay COHEN, Netanya (IL); Taras KHOMITSKY, Netanya (IL); Samy HAZAN, Netanya (IL)

(21) Appl. No.: 18/496,875

(22) Filed: Oct. 29, 2023

Related U.S. Application Data
(63) Continuation of application No. 18/001,473, filed on Dec. 12, 2022, now Pat. No. 11,832,587.

(30) Foreign Application Priority Data
Jun. 18, 2020 (IL) 275518

(51) Int. Cl. A01K 11/00; A01K 29/00

(52) U.S. Cl. CPC A01K 11/004; A01K 29/005

(57) ABSTRACT

an animal tag comprising: a one-piece animal tag retaining member made of molded material, having: a first part comprising a female opening connectable to a male member for coupling the animal tag to a body part of an animal; a second part configured to accommodate one or more electronical components capable of obtaining information relating to the animal to which the animal tag is coupled; an intermediate part, located between the first tag part and the second tag part, having a form of a latitudinal recess for enhancing a flexibility of the animal tag.

### TECHNICAL FIELD

The invention relates to an animal tag.

### BACKGROUND

Livestock monitoring solutions have become increasingly important in understanding the nutrition, production, management of the well-being, and overall health of individual animals in a dairy farm. Methods of assessing behavioral activity have changed in recent years, favoring automatic recording techniques. Traditional methods to measure behavior, such as direct observation, are labor-intensive and time-consuming. Automated recording devices have become increasingly common to measure behavior accurately. Thus, the development of automated monitoring systems that can continuously and accurately quantify and/or monitor reproduction, health, location and nutrition are required for efficient management and control of modem and automated dairy farms.

Certain monitoring solutions use a monitoring tag that is mounted on animal's ear. One of the main problems with monitoring tags currently available on the market is relatively short durability and poor quality. Animal tags should be designed to survive harsh weather conditions and the wear and tear of being attached to an animal. In some cases, animal tags are transferred from one animal to another, which also requires high durability.

Poor tag retention affects the accuracy and availability of livestock monitoring data and emergency response time. The costs of replacing the monitoring tags is far higher than the cost of the tags alone as the tagging process can be extremely labor intensive. The cattle first need rounding up and taking to an appropriate handling area to be safely tagged. The farmer has to inspect every animal to discover how many tags are missing, then he also needs to spend the time ordering new tags. For large beef farms, accommodating hundreds, or thousands cattle heads, inspecting all of their animals individually is an extremely arduous task.

Therefore, there is a growing need to provide a new animal tag.

### GENERAL DESCRIPTION

In accordance with a first aspect of the presently disclosed subject matter, there is provided an animal tag comprising: a one-piece animal tag retaining member made of molded material, having: a first part comprising a female opening connectable to a male member for coupling the animal tag to a body part of an animal; a second part configured to accommodate one or more electronical components capable of obtaining information relating to the animal to which the animal tag is coupled; an intermediate part, located between the first tag part and the second tag part, having a form of a latitudinal recess for enhancing a flexibility of the animal tag.

In some cases, the animal tag further comprising a Light Emitting Diode (LED) capable of providing light indications visible to a user when the animal tag is attached to the animal.

In some cases, the electronical components include a Near-Field Communication (NFC) tag uniquely identifying the animal tag.

In some cases, the molded material is made of at least one of: polymeric material or polyurethane.

In some cases, the electronical components include one or more of: a three-dimensional accelerometer, a temperature sensor or a light sensor.

In some cases, the second part is molded to accommodate the electronical components, thereby sealing the molded material including the electronical components.

In some cases, the electronical components are accommodated within a casing and wherein the second part of the molded material is molded to accommodate the casing thereby sealing the molded material including the casing.

In some cases, the second part of the molded material has an opening for inserting the electronical components, and wherein after insertion of the electronical components the second part is sealed using a cover welded to the second part by welding.

In some cases, the electronical components are accommodated within a casing.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1 is a pictorial schematic view of an animal tag in an operational position, in accordance with the presently disclosed subject matter;

FIG. 2A is a front perspective view of an animal tag, in accordance with the presently disclosed subject matter;

FIG. 2B is a rear perspective view of an animal tag, in accordance with the presently disclosed subject matter;

FIG. 3A is a cross-sectional side view illustrating one example of an animal tag, in accordance with the presently disclosed subject matter;

FIG. 3B is a cross-sectional side view illustrating another example of an animal tag, in accordance with the presently disclosed subject matter;

FIG. 4A is a partial front view illustrating one example of an intermediate part of an animal tag, in accordance with the presently disclosed subject matter; and

FIG. 4B is a partial front view illustrating another example of an intermediate part of an animal tag, in accordance with the presently disclosed subject matter.

### DETAILED DESCRIPTION

In the following detailed description, numerous specific details are set forth in order to provide a thorough understanding of the presently disclosed subject matter. However, it will be understood by those skilled in the art that the presently disclosed subject matter may be practiced without these specific details. In other instances, well-known methods, procedures, and components have not been described in detail so as not to obscure the presently disclosed subject matter.

In the drawings and descriptions set forth, identical reference numerals indicate those components that are common to different embodiments or configurations.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus, the appearance of the phrase “one case”, “some cases”, “other cases” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

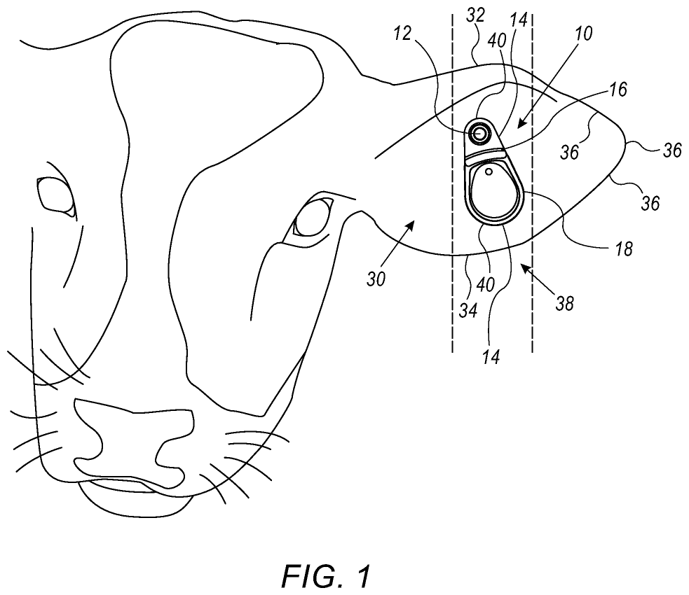

Bearing this in mind, attention is drawn to FIG. 1, which is a pictorial schematic view of an exemplary animal tag 10 in an operational position, in accordance with the presently disclosed subject matter. The animal tag 10 (also referred to herein as “tag”) comprising a one-piece animal tag retaining member 12 having a first part 14, a second part 16 and an intermediate part 18. In the operational position, the tag may be mounted on an animal, for example on an animal's ear for identification and/or tracking and/or monitoring purposes. For example, the tag can monitor reproductive status of every individual heifer and cow in a dairy farm based on their behavioral activities such as physical activity, rumination, eating and other proprietary key behaviors. The presently disclosed tag 10 is suited for various types of animals, and in some specific examples it can be particularly adapted for use with cattle. The tag 10 can be designed specifically to fit an animal's ear, such as a cattle's ear, and for this purpose it is of a relatively small size and of relatively low weight. One non-limiting example of the dimensions of the tag 10 can be 70 mm×40 mm×15 mm, and one non-limiting example of the weight of the tag 10 can be 25 grams.

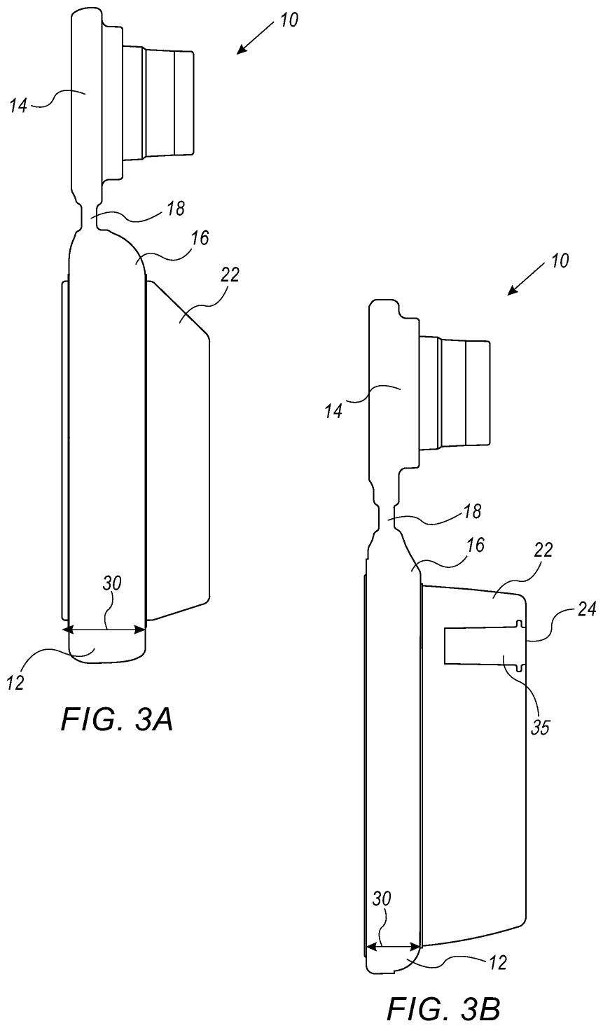

As generally illustrated the example shown in FIG. 1, the ear of a cow 30 having generally horizontally extending outer portions 32, 34 with an oval ending 36. There is an area 38 in the ear of the cow 30 that is particularly well suited for mounting the animal tag 10 of the presently disclosed subject matter thereon. The area 38 is located approximately in the middle one-third of the ear or one third the distance between a junction point of the ear of the cow 30 with the head of the cow and an outer end of the ear. The tagging location should be between the rises in auricular cartilage or the ribs (not shown in the figures). This area 38 is characterized by a relatively flat surface that is substantially free of hair (as other areas of cow's ear tend to be abundant of hair and can, for example, obscure light indicator of the tag 10 as further detailed hereinbelow with respect to FIG. 3B).

In general, the one-piece animal tag retaining member 12 having an oval peripheral configuration with substantially round end portions 40 and round edges throughout the peripheral configuration. Such configuration minimizes animal's negative experience as it does not provide inconvenience or injury during animal's ear movement while wearing the tag. Further, the rear surface of the one-piece animal tag retaining member 12 is substantially flat so that upon mounting the tag 10 on animal's ear it is substantially aligned therewith. The one-piece animal tag retaining member 12 is manufactured of a molded material such as polymeric material, polyurethane or the like.

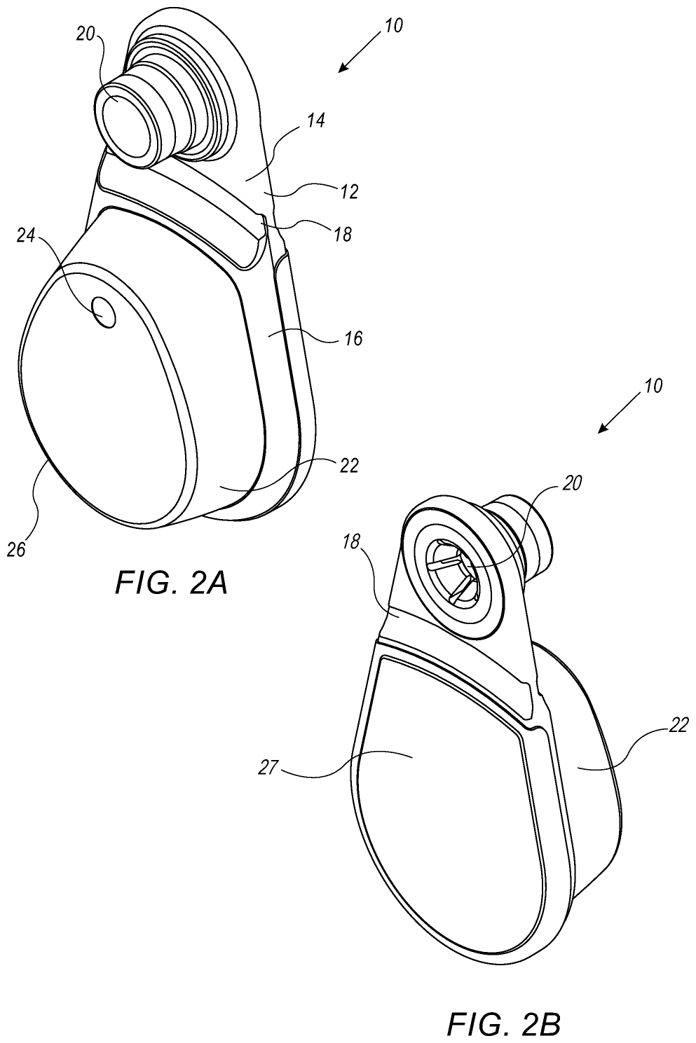

Reference is currently made to FIG. 2A, which is a front perspective view of an exemplary animal tag 10, in accordance with the presently disclosed subject matter. The first part 14 of the one-piece animal tag retaining member 12 has a female opening 20 that is configured to be mechanically connected to a male member (not shown in the figures) in order to manually secure the tag 10 to a body part of an animal (e.g. animal's ear, as depicted in FIG. 1). The female opening 20 having a tubular body projecting outwardly from the first part 14 of the one-piece animal tag retaining member 12 and comprising locking means therein configured to interlock with the male member to secure the tag 10 to a body part of an animal (e.g. animal's ear, as depicted in FIG. 1). The second part 16 of the one-piece animal tag retaining member 12 is configured to accommodate a casing 22 wherein one or more electronical components can be disposed. The casing 22 can have a substantially oval body extending outwardly from the second part 16 of the one-piece animal tag retaining member 12 and having a substantially enclosed space therein to receive the electronical components. In some cases, the casing 22 can be sealed with a cover 27 by means of welding, as further detailed hereinbelow with respect to FIG. 3B, in other cases, the casing 22 can be sealed with either screws, adhesive, and/or both and/or any other sealing means—as known in the art.

In some cases, the casing 22 can have an opening 24 on an outer surface 26 thereof for allowing light passage therethrough, or placement of a light source (e.g. a light emitting diode) extending outwards therethrough, as further detailed hereinbelow with respect to FIG. 3B.

The electronical components are capable of obtaining information relating to the animal to which the animal tag 10 is coupled (e.g. for identification and/or tracking and/or monitoring purposes).

In some cases, the electronical components may include a Near-Field Communication (NFC) tag configured to identify the tag 10 worn by the animal. The NFC tag is utilized as an electronic ID card for the tag 10, having a unique tag number, that can enable providing information related to the animal, such as but not limited to, its variety, source, production performance, immune status, health status, owner and other information. Information can be read from the NFC tag using an appropriate reader without needing close contact with the animal. The NFC tag is advantageous over metal or plastic ear tags for example wherein the writing on them often disappears with time.

In some cases, the electronical components may include a three-dimensional accelerometer suited for measuring and recognizing behavioral patterns of individual animals in a dairy farm. It can measure and record three-dimensional movement of the animal wearing the tag 10 (i.e. record horizontal, vertical and lateral acceleration thereof). Measured behavioral patterns may include standing, lying, ruminating, eating, normal and lame walking, lying down, and standing up. Additionally, the three-dimensional accelerometer can be utilized to recognize animal's ear postures, which may indicate the emotional state of the animal wearing the tag 10. For example, studies showed that cows exhibit four different ear postures (e.g. two “relaxed” ear postures and two “alert” postures) wherein each posture is indicative of positive or negative emotion.

In some cases, the electronical components may include a temperature sensor suited for measuring a body temperature of the animal wearing the tag 10 and/or ambient temperature of the animal's surroundings.

In some cases, the electronical components may include a light sensor that can be used to measure the amount of ambient light and set the LED power in accordance to the light conditions—for example, when it's dark we can reduce the LED power and by that preserve battery capacity.

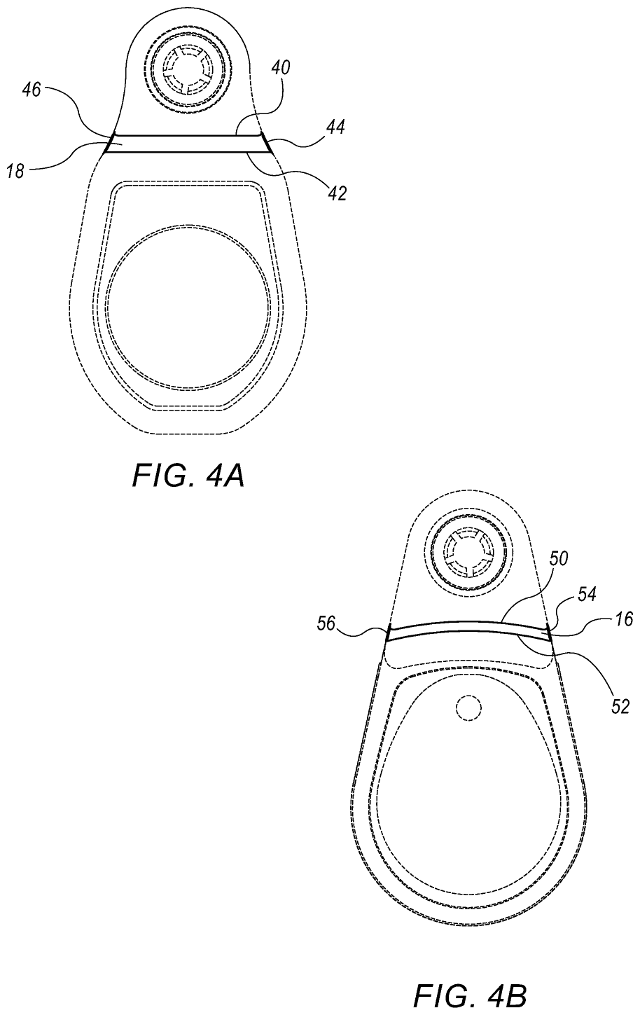

The intermediate part 18 of the one-piece animal tag retaining member 12 is located between the first part 14 and the second part 16 thereof and has a form of a latitudinal recess for enhancing a flexibility of the tag 10, as further detailed hereinbelow with respect to FIGS. 4A-4B.

Reference is currently made to FIG. 3A, which is a cross-sectional side view illustrating one example of an animal tag 10, in accordance with the presently disclosed subject matter. In some cases, during the manufacturing process of the tag 10, the second part 16 of the one-piece animal tag retaining member 12 is molded around a peripheral configuration 30 of the casing 22, wherein one or more electronical components are disposed therein, thereby retaining the casing 22 thereto. In these cases, the electronical components are accommodated within the casing 22 and the second part 16 of the molded material is molded to accommodate the casing 22 thereby sealing the molded material including the casing 22.

As shown in FIG. 3A, the intermediate part 18 of the one-piece animal tag retaining member 12 is an integrally molded portion thereof having substantially thinner width (when looking at a cross-section side view illustrated in FIG. 3A) with respect to the first part 14 and the second part 16 of the one-piece animal tag retaining member 12, i.e. having a form of a latitudinal recess in the one-piece animal tag retaining member 12. In some cases, the latitudinal recess includes horizontal traverse portions 40, 42 and inclined side surfaces 44, 46 as depicted in FIG. 4A. This configuration of the intermediate part 18 enhances flexibility and durability of the one-piece animal tag retaining member 12 thereby enabling high retention period of the tag 10 on the animal's ear. For example, cow has very mobile ears, whose movement apply torque on a monitoring tag while it is attached to the cow's ear. Consequently, the tag can break or be torn out and lost. The latitudinal recess in the intermediate part 18 of the one-piece animal tag retaining member 12 provides improved flexibility and durability to the tag 10 thereby enabling resiliency/withstand once torque is applied on the tag 10.

It is to be noted that in some cases, the intermediate part 18 can have a structure having different levels of thinness, such as a steps structure or a slope structure (i.e. the intermediate part 18 can have more than one level of thinness).

Reference is currently made to FIG. 3B, which is a cross-sectional side view illustrating another example of an animal tag 10, in accordance with the presently disclosed subject matter. In some cases, during the manufacturing process of the tag 10, the second part 16 of the one-piece animal tag retaining member 12 is molded around a peripheral configuration 30 of the casing 22, wherein one or more electronical components are not disposed therein, thereby retaining the casing 22 thereto. In such cases, the second part 16 of the molded material has an opening (not shown in the figures) for inserting the electronical components into casing 22, and after insertion of the electronical components the second part 16 of the one-piece animal tag retaining member 12 is sealed, e.g. using a cover 27 welded to the second part 16 of the one-piece animal tag retaining member 12, e.g. by means of welding, as depicted in FIG. 2B showing a rear perspective view of an animal tag 10, in accordance with the presently disclosed subject matter.

In some cases, the casing 22 can further comprise a tube 35 configured to accommodate a light source (e.g. a light emitting diode) therein. The light source is capable of providing light indications visible to a user when the animal tag 10 is attached to the animal, thereby alerting the user for various reasons. For example, a LED light, which is visible during the day and night, is configured to turn on continuously or in a flashed manner when the animal wearing the tag 10 is sick or having for example a temperature above a predetermined threshold (e.g. temperature above 39.7 Celsius is typical for a respiratory infection in cattle).

As shown in FIG. 3B the intermediate part 18 of the one-piece animal tag retaining member 12 is an integrally molded portion thereof having substantially thinner width respect to the first part 14 and the second part 16 of the one-piece animal tag retaining member 12, i.e. having a form of a latitudinal recess in the one-piece animal tag retaining member 12. In some cases, the latitudinal recess having slightly curved horizontal traverse portions 50, 52 and inclined side surfaces 54, 56 as depicted in FIG. 4B. Such configuration enhances flexibility of the one-piece animal tag retaining member 12 thereby enabling high retention period of the tag 10 on the animal's ear. For example, cow has very mobile ears, whose movement apply torque on a monitoring tag while it is attached to cow's ear. Consequently, the tag can be torn out and lost or break. The latitudinal recess in the intermediate part 18 of the one-piece animal tag retaining member 12 provides flexibility to the tag 10 thereby enabling resiliency to application of torque on the tag 10.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

In the foregoing specification, the presently disclosed subject matter has been described with reference to specific examples of embodiments of the presently disclosed subject matter. It will, however, be evident that various modifications and changes may be made therein without departing from the broader spirit and scope of the presently disclosed subject matter as set forth in the appended claims.

It is to be noted that other modifications, variations and alternatives are also possible. The specifications and drawings are, accordingly, to be regarded in an illustrative rather than in a restrictive sense.

While certain features of the presently disclosed subject matter have been illustrated and described herein, many modifications, substitutions, changes, and equivalents will now occur to those of ordinary skill in the art. It is, therefore, to be understood that the appended claims are intended to cover all such modifications and changes as fall within the true spirit of the presently disclosed subject matter.

1. An animal tag comprising:
a one-piece animal tag retaining member made of molded material, having:
a first part comprising a female opening connectable to a male member for coupling the animal tag to a body part of an animal;
a second part configured to accommodate one or more electronical components capable of obtaining information relating to the animal to which the animal tag is coupled;
an intermediate part, located between the first tag part and the second tag part, having a form of a latitudinal recess for enhancing a flexibility of the animal tag.

2. The animal tag of claim 1, further comprising a Light Emitting Diode (LED) capable of providing light indications visible to a user when the animal tag is attached to the animal.

3. The animal tag of claim 1, wherein the electronical components include a Near-Field Communication (NFC) tag uniquely identifying the animal tag.

4. The animal tag of claim 1, wherein the molded material is made of at least one of: polymeric material or polyurethane.

5. The animal tag of claim 1, wherein the electronical components include one or more of: a three-dimensional accelerometer, a temperature sensor or a light sensor.

6. The animal tag of claim 1, wherein the second part is molded to accommodate the electronical components, thereby sealing the molded material including the electronical components.

7. The animal tag of claim 6, wherein the electronical components are accommodated within a casing and wherein the second part of the molded material is molded to accommodate the casing thereby sealing the molded material including the casing.

8. The animal tag of claim 1, wherein the second part of the molded material has an opening for inserting the electronical components, and wherein after insertion of the electronical components the second part is sealed using a cover welded to the second part by welding.

9. The animal tag of claim 8, wherein the electronical components are accommodated within a casing.
